(19) United States
(12) Patent Application Publication
(10) Pub. No.: US 2021/0166852 A1
(43) Pub. Date: Jun. 3, 2021

(54) COMBINATION SOLENOID APPARATUS AND PRINTED CIRCUIT BOARD, AND ASSOCIATED METHOD

(71) Applicant: EATON INTELLIGENT POWER LIMITED, DUBLIN (IE)

(72) Inventor: MARTIN EDWARD PLUTKO, ALIQUIPPA, PA (US)

(73) Assignee: EATON INTELLIGENT POWER LIMITED, DUBLIN (IE)

(21) Appl. No.: 17/171,740

(22) Filed: Feb. 9, 2021

Related U.S. Application Data
(63) Continuation of application No. 15/364,408, filed on Nov. 30, 2016, now abandoned.

(51) Int. Cl. H01F 7/126

(52) U.S. Cl. CPC H01F 7/126

(57) ABSTRACT

A solenoid apparatus is combined with a printed circuit board to form an improved combination of structures. The solenoid apparatus includes a solenoid that is situated on a frame that is formed from an electrically nonconductive material. In another embodiment, a frame of a solenoid apparatus is modified to remove a dependent structure in order to avoid a frame from being soldered together with an electrical connector of a solenoid. In a third embodiment, a solenoid apparatus includes a frame having a protuberance that is situated at a location spaced equally from each of a pair of electrical connectors of the coil. In a fourth embodiment, a solenoid apparatus includes a frame with a protruding structure, but the protruding structure is spaced from a circuit board and thus does not become electrically connected therewith. A method is also disclosed.

### BACKGROUND

### Field

The disclosed and claimed concept relates generally to electrical equipment and, more particularly, to a combination that includes a printed circuit board and a solenoid apparatus.

### Background

Solenoids are electrical devices that are used in a variety of applications. Solenoids typically each include a coil that is mounted upon some type of a frame or support, or the coil can have a coating applied thereto that serves as the support. The support of a solenoid can be formed of any of a wide variety of materials.

In some applications, a solenoid is mounted on a printed circuit board and is electrically connected therewith. Difficulty has occasionally been encountered in situations where the frame is formed of an electrically conductive material, such as metal or other such material, inasmuch as the frame can become electrically connected with certain of the electrically conductive components of the printed circuit board. This problem is exacerbated in the region where the electrical connectors of the coil are soldered to the conductive structures on the printed circuit board, especially if this is in the vicinity of an electrically conductive frame.

Sometimes a solenoid has been mounted on an electrically conductive frame that includes a depending structure that is situated in the vicinity of one of the electrical connectors of the coil. Such a geometry can be been particularly troublesome because great difficulty is typically experienced in soldering the electrical connector without also soldering the depending structure at the same time. Permitting a portion of a frame to be electrically connected with a portion of a printed circuit board is undesirable because it can result in the frame being electrified and can cause other problems. Improvements thus would be desirable.

### SUMMARY

An improved solenoid apparatus is combined with a printed circuit board to form an improved combination of structures. The solenoid apparatus includes a solenoid that is situated on a frame that is formed from an electrically nonconductive material. In another embodiment, a frame of a solenoid apparatus is modified to remove a dependent structure in order to avoid a frame from being soldered together with an electrical connector of a solenoid. In a third embodiment, a solenoid apparatus includes a frame having a protuberance that is situated at a location spaced equally from each of a pair of electrical connectors of the coil. In a fourth embodiment, a solenoid apparatus includes a frame with a protruding structure, but the protruding structure is spaced from a circuit board and thus does not become electrically connected therewith.

Accordingly, an aspect of the disclosed and claimed concept is to provide an improved combination that includes an improved solenoid apparatus and a printed circuit board wherein the solenoid apparatus includes a frame that is electrically disconnected from the printed circuit board.

Another aspect of the disclosed and claimed concept is to provide an improved method of avoiding a frame of a solenoid apparatus from becoming electrically connected with a printed circuit board with which a solenoid of the solenoid apparatus is electrically connected.

As such, an aspect of the disclosed and claimed concept is to provide an improved combination that can be generally stated as including a solenoid apparatus that can be generally stated as including a solenoid and a frame, the solenoid can be generally stated as including a coil situated on the frame and a pair of electrical connectors that are electrically connected with the coil, the pair of electrical connectors being situated adjacent the frame and protruding beyond an edge of the frame, and a printed circuit board having a number of conductive elements, the pair of electrical connectors being electrically connected with at least a portion of the number of conductive elements, the frame being electrically disconnected from the number of conductive elements.

Another aspect of the disclosed and claimed concept is to provide an improved method of avoiding a frame of a solenoid apparatus from becoming electrically connected with a printed circuit board having a number of conductive elements. The solenoid apparatus can be generally stated as including a solenoid and a frame. The solenoid can be generally stated as including a coil situated on the frame and a pair of electrical connectors that are electrically connected with the coil, the pair of electrical connectors being situated adjacent the frame and protruding beyond an edge of the frame, the pair of electrical connectors being electrically connected with at least a portion of the number of conductive elements. The method can be generally stated as including performing at least one of: i) prior to electrically connecting the pair of electrical connectors with the at least portion of the number of conductive elements, removing from the edge a protuberant structure that is situated adjacent an electrical connector of the pair of electrical connectors, ii) providing the frame with a protuberance situated on the edge and spaced substantially equally from each of the electrical connectors of the pair of electrical connectors, iii) forming the frame out of an electrically insulative material, and iv) configuring the frame to have a protruding structure situated on the edge, with the edge and the protruding structure being spaced from the printed circuit board when the pair of electrical connectors are electrically connected with the at least portion of the number of conductive elements.

### BRIEF DESCRIPTION OF THE DRAWINGS

A further understanding of the disclosed and claimed concept will be gained from the following Description when read in conjunction with the accompanying drawings wherein:

FIG. 1 is perspective view of an improved solenoid apparatus;

FIG. 2 is an end view of the solenoid apparatus of FIG. 1;

FIG. 3 is a view of an improved combination demonstrating the solenoid apparatus of FIG. 1 being assembled to a printed circuit board;

FIG. 4 is a side view of the combination of FIG. 3, partially cut away;

FIG. 5 is a view of an improved combination in accordance with a second embodiment of the disclosed and claimed concept;

FIG. 6 is a view of an improved combination in accordance with a third embodiment of the disclosed and claimed concept;

FIG. 7 is a view of an improved combination in accordance with a fourth embodiment of the disclosed and claimed concept; and

FIG. 8 is a side view, partially cut away, of the fourth embodiment.

Similar numerals refer to similar parts throughout the specification.

### DESCRIPTION

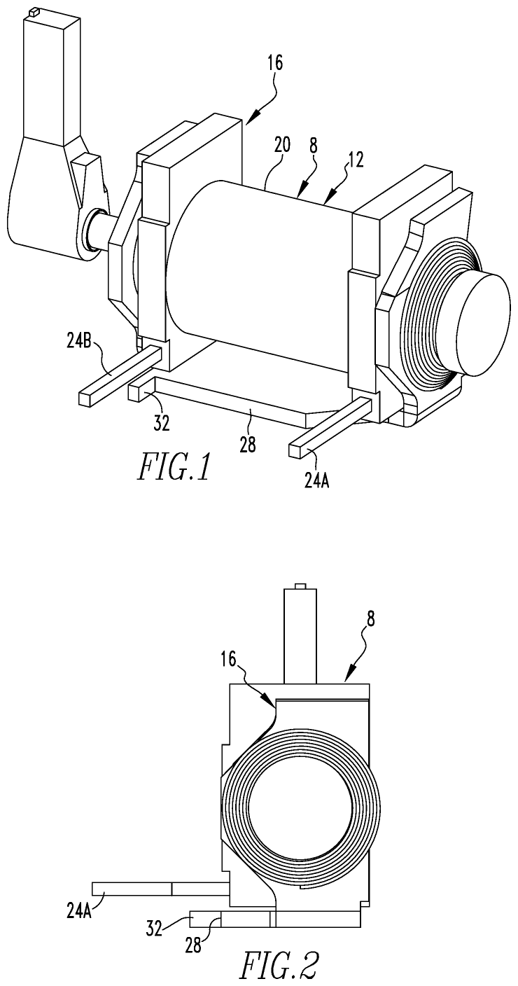

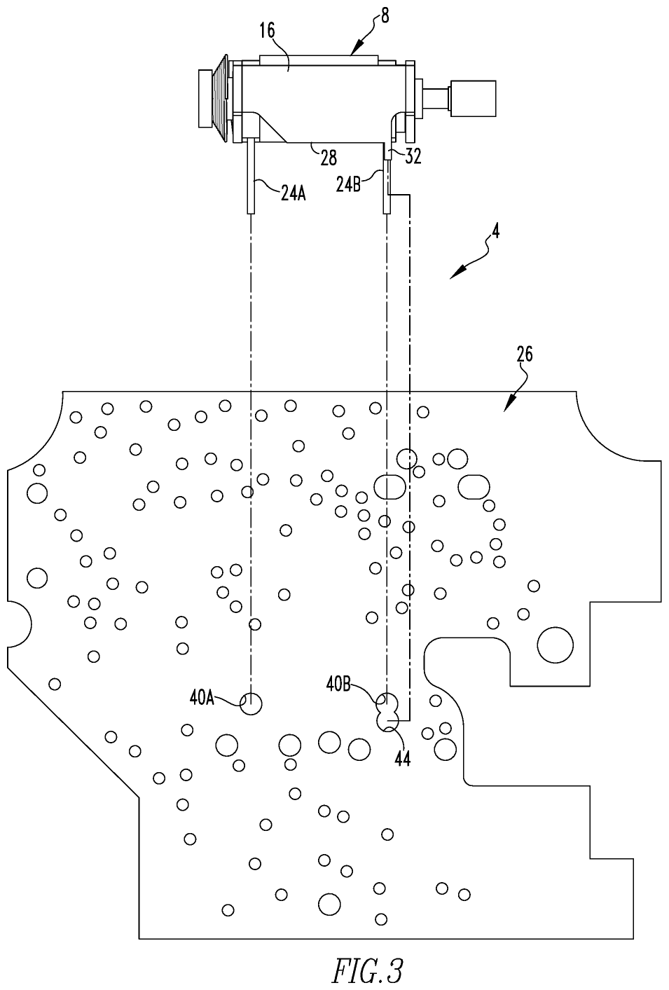

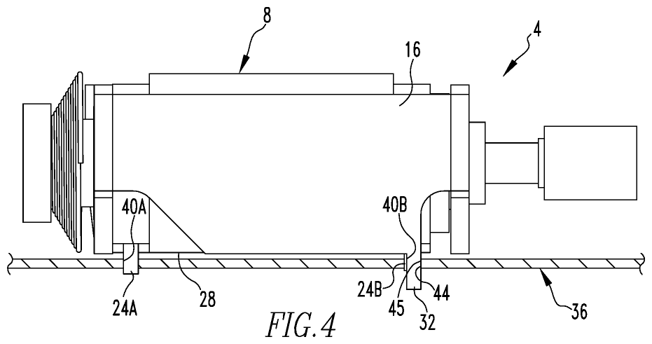

An improved solenoid apparatus 8 in accordance with the disclosed and claimed concept is depicted in FIGS. 1-4. The solenoid apparatus 8 is a part of an improved combination 4 that is in accordance with the disclosed and claimed concept and that is depicted in FIGS. 3 and 4 and that will be discussed in greater detail elsewhere herein. The combination 4 includes, in addition to the solenoid apparatus 8, a printed circuit board 36 such as is depicted in FIG. 3. The solenoid apparatus 8 is advantageously configured to avoid unintended electrical connection between it and the printed circuit board 36.

The solenoid apparatus 8 can be said to include a solenoid 12 and a frame 16, with the solenoid 12 being situated on the frame 16. The frame is formed of an electrically nonconductive material, i.e., an electrically insulative material, such as plastic, glass-filled resin, or any of a variety of other nonconductive materials.

The solenoid 12 includes a coil 20 and a pair of electrical connectors 24A and 24B (which may be collectively or individually referred to herein with the numeral 24) that are electrically connected with the coil 20. The frame 16 has an elongated edge 28, and the electrical connectors 24 protrude beyond the edge 28, as can be seen in FIGS. 1 and 2.

As can be seen in FIG. 3, the printed circuit board 36 includes a plurality of conductive elements that are indicated generally at the numeral 40, and two particular ones of which are indicated at the numerals 40A and 40B. The printed circuit board 36 additionally includes a number of openings formed therein, one of which is indicated at the numeral 44 and which is situated adjacent the conductive element 40B.

As can be understood from FIGS. 1-4, the frame 16 includes a lug 32 that protrudes outwardly therefrom beyond the edge 28. When the solenoid apparatus 8 is mounted to the printed circuit board 36, the electrical connector 24A is received in the conductive element 40A (which is in the form of a receptacle), the electrical connector 24B is received in the conductive element 40B (which is likewise in the form of a receptacle), and the lug 32 is received in the opening 44. In performing the installation, the electrical connector 24A and the conductive element 40A are soldered together, and the electrical connector 24B and the conductive element 40B are likewise soldered together. For the sake of completeness, it is noted that other methodologies may be employed to electrically connect the electrical connectors 24 with the conductive elements 40. The portions of the electrical connectors 24 that protrude beyond the printed circuit board 36 are then trimmed to result in the assembly as indicated in FIG. 4.

Notably, since the frame 16 and thus the lug 32 are formed of an electrically insulative and non-conductive material, the proximity of the lug 32 to the conductive element 40B when the combination 4 is assembled will not result in the frame 16 being electrified. The lug 32 can even be affixed in the opening 44 such as through the use of adhesives or other materials, and the lug 32 thus can physically affix the frame 16 to the printed circuit board 36 to provide additional support for the solenoid 12. Nevertheless, the frame 16 advantageously is not electrified because the frame 16 is formed on an electrically insulative material.

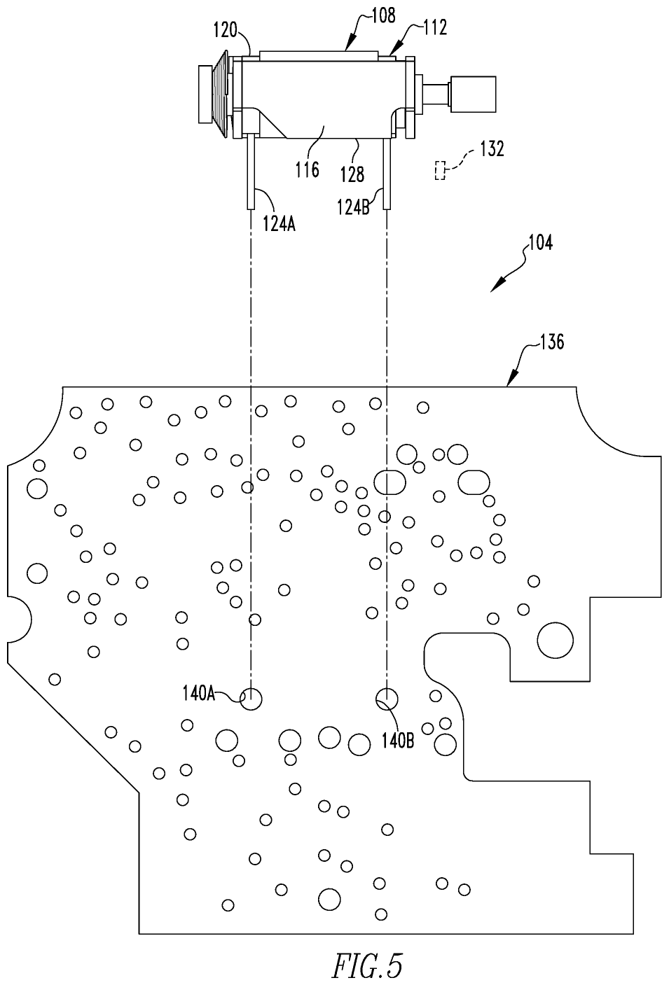

An improved combination 104 in accordance with a second embodiment of the disclosed and claimed concept is depicted in FIG. 5 as including an improved solenoid apparatus 108 and a printed circuit board 136. The solenoid apparatus 108 is different from the solenoid apparatus 8 because the solenoid apparatus 108 includes a frame 116 that is formed of an electrically conductive material. The frame 116 is manufactured with an edge 128 and a protuberant structure 132, but the protuberant structure 132 is removed from the frame 116, such as by cutting or other appropriate methodology.

The solenoid apparatus 108 further includes a solenoid 112 having a coil 120 and a pair of electrical connectors 124A and 124B that are electrically connected with a pair of conductive openings 140A and 140B of a printed circuit board 136. Since the protuberant structure 132 is removed from the frame 116 prior to the solenoid apparatus 108 being mounted to the printed circuit board 136 to form the combination 104, the printed circuit board 136 need not have an opening formed therein to receive the protuberant structure 132. Since the edge 128 of the frame 116 may be situated closely adjacent the printed circuit board 136 after the combination 104 is formed, it may be desirable to configure the printed circuit board 136 such that no conductive elements underlie the edge 128 or, potentially, to slightly space the edge 128 from the printed circuit board 136. In the combination 104, the frame 116 is advantageously not electrified because the protuberant structure 132 which might have been electrically connected with the conductive element 140B has been removed from the frame 116 prior to assembly of the combination 104.

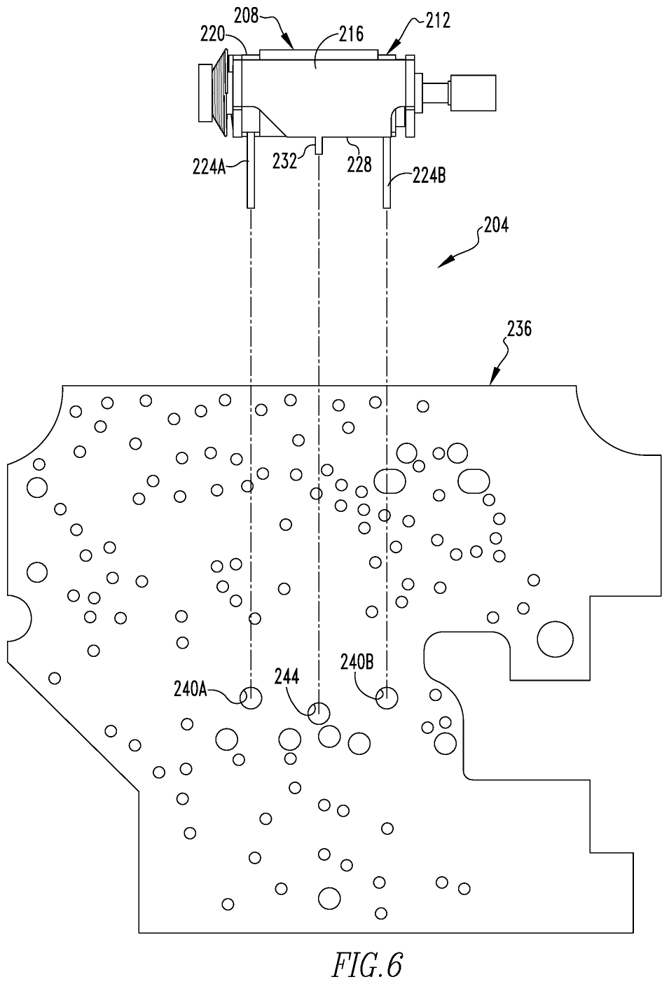

An improved combination 204 in accordance with a third embodiment of the disclosed and claimed concept is depicted generally in FIG. 6. The combination 204 includes a solenoid apparatus 208 and a printed circuit board 236. The solenoid apparatus 208 includes a solenoid 212 situated on a frame 216, with the solenoid 212 including a coil 220 and a pair of electrical connectors 224A and 224B.

As can be understood from FIG. 6, the frame 216 has an edge 228 and further has a protuberance 232 that protrudes from the edge 228. It is noted, however, that the protuberance 232 is configured to be situated such that it is spaced a substantially equal distance from both of the electrical connectors 224A and 224B.

The printed circuit board 236 includes a pair of conductive elements 240A and 240B that are electrically connected with the electrical connectors 224A and 224B, respectively. The printed circuit board 236 further has an opening 244 formed therein that is spaced equally from the conductive elements 240A and 240B.

The frame 216 may be formed of an electrically conductive material such as metal, or it may alternatively be formed of an electrically nonconductive material. Regardless, the frame 216 is electrically disconnected with the printed circuit board 236 inasmuch as the protuberance 232 is spaced equally from the electrical connectors 224A and 224B as well as from the conductive elements 240A and 240B. As such, when the solenoid apparatus 208 is received on the printed circuit board 236, the electrical connectors 224A and 224B are received in the conductive elements 240A and 240B, respectively, and the protuberance 232 is received in the opening 244.

The electrical connector 224A and the conductive element 240A can be electrically connected together, and the electrical connector 224B and the conductive element 240B can likewise be electrically connected together, such as by soldering or other methodology, without a meaningful risk of the protuberance 232 becoming electrically connected with either of the conductive elements 240A and 240B since it is spaced equally from each. The protuberance 232 can be affixed in the opening 244, such as with the use of adhesives or some other appropriate affixing methodology, thereby enabling the printed circuit board 236 to provide physical support to the frame 216 and thus to the solenoid 212, which is advantageous, without a meaningful concern of the frame 216 becoming electrified.

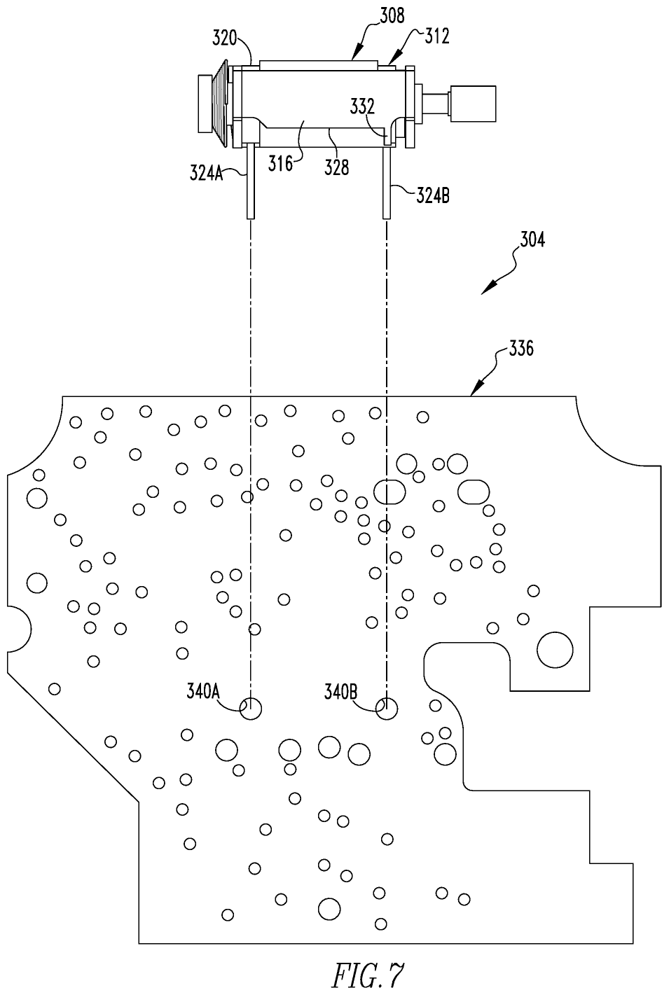

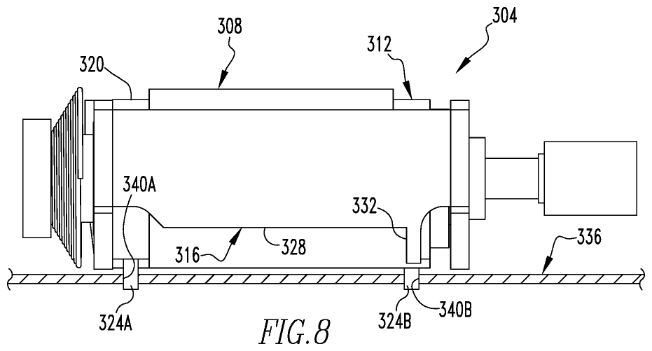

An improved combination 304 in accordance with a fourth embodiment of the disclosed and claimed concept is depicted generally in FIGS. 7 and 8. The combination 304 includes a solenoid apparatus 308 and a printed circuit board 336. The solenoid apparatus 308 includes a solenoid 312 and a frame 316, with the solenoid 312 being situated on the frame 316 and including a coil 320 and a pair of electrical connectors 324A and 324B that are electrically connected with the coil 320. The frame 316 is formed of an electrically conductive material, such as metal or other such material, and is configured to include an edge 328 and further include a protruding structure 332 that protrudes from the edge 328. It is noted, however, that the edge 328 is positioned such that the free end of the protruding structure 332 is spaced from the printed circuit board 336 and is thus also spaced from a pair of conductive elements 340A and 340B of the printed circuit board 336 when the solenoid apparatus 338 is mounted thereon. As such, no opening needs to be formed in the printed circuit board 336 for the reception of the protruding structure 332 inasmuch as the protruding structure 332 is spaced from the printed circuit board 336.

As such, even though the frame 316 may be formed of an electrically conductive material, the frame 316 is electrically isolated from the printed circuit board 336 by virtue of the frame 316 and the protruding structure 332 being spaced from the printed circuit board 336, thus effectively electrically insulating the printed circuit board 336 and the frame 316 from one another. The solenoid 312 and its coil 320 can thus be electrically connected with the printed circuit board 336 without the frame 316 additionally becoming electrically connected with the printed circuit board 336.

It thus can be seen that the combinations 4, 104, 204, and 304 are each advantageously configured to avoid having the frame 16, 116, 216, and 316, respectively, become electrically connected with the printed circuit board 36, 136, 236, and 336, respectively. Avoiding such electrification of the frames is highly desirable for the reasons set forth elsewhere herein.

Also disclosed is an improved method of avoiding the frame 16, 116, 216, and 316 from becoming electrically connected with the printed circuit board 36, 136, 236, and 336. The method includes any one or more of i) prior to electrically connecting the pair of electrical connectors with the conductive elements, removing a protuberant structure from an edge of a frame that is electrically conductive, ii) providing a frame with a protuberance situated on the edge and spaced substantially equally from the electrical connectors, iii) forming the frame out of an electrically insulative material, and iv) configuring the frame to have a protruding structure, but configuring the frame such that the protruding structure is spaced from the printed circuit board. Other variations will be apparent.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1-6. (canceled)

7. A combination comprising:
a solenoid apparatus comprising a solenoid and a frame, the frame having an edge, the solenoid comprising a coil situated on the frame and a pair of electrical connectors that are electrically connected with the coil, the pair of electrical connectors being situated adjacent the frame and protruding beyond the edge, the frame being formed of a material that is electrically conductive, the edge being free of protuberant structures adjacent the pair of electrical connectors; and
a printed circuit board having a number of conductive elements, the pair of electrical connectors being electrically connected with at least a portion of the number of conductive elements, the frame being electrically disconnected from the number of conductive elements.

8. A method of avoiding a frame of a solenoid apparatus from becoming electrically connected with a printed circuit board having a number of conductive elements, the solenoid apparatus comprising a solenoid and a frame, the solenoid comprising a coil situated on the frame and a pair of electrical connectors that are electrically connected with the coil, the pair of electrical connectors being situated adjacent the frame and protruding beyond an edge of the frame, the pair of electrical connectors being electrically connected with at least a portion of the number of conductive elements, the method comprising, prior to electrically connecting the pair of electrical connectors with the at least portion of the number of conductive elements, removing from the edge a protuberant structure that is situated adjacent an electrical connector of the pair of electrical connectors.

9. The method of claim 8, further comprising forming the frame from a material that is electrically conductive.
